(19) United States
(12) Patent Application Publication
(10) Pub. No.: US 2004/0004758 A1
(43) Pub. Date: Jan. 8, 2004

(54) Device for protecting against humidity in an inverted microscope

(76) Inventors: Leander Dietzsch, Jena (DE); Matthias Gonschor, Gleichen (DE); Bernd Faltermeier, Aalen (DE); Barbara Von Der Gathen, Aalen (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/398,617

(22) PCT Filed: Oct. 2, 2001
(86) PCT No.: PCT/EP01/11379

(30) Foreign Application Priority Data
Oct. 6, 2000 (DE) 10050825.1

(51) Int. Cl. G02B 21/00

(52) U.S. Cl. 359/368

(57) ABSTRACT

Protective device for preventing moisture from entering the parts of an inverted microscope located below the specimen stage, wherein a preferably flexible cover is provided for the objective turret, which cover is adapted to the shape of the turret and has recesses for the objectives and an at least partially circumferential gutter below the cover for collecting liquid.

The invention is directed to a protective device for preventing moisture from entering the parts of an inverted microscope which are located below the specimen stage, particularly the objective turret and the stand.

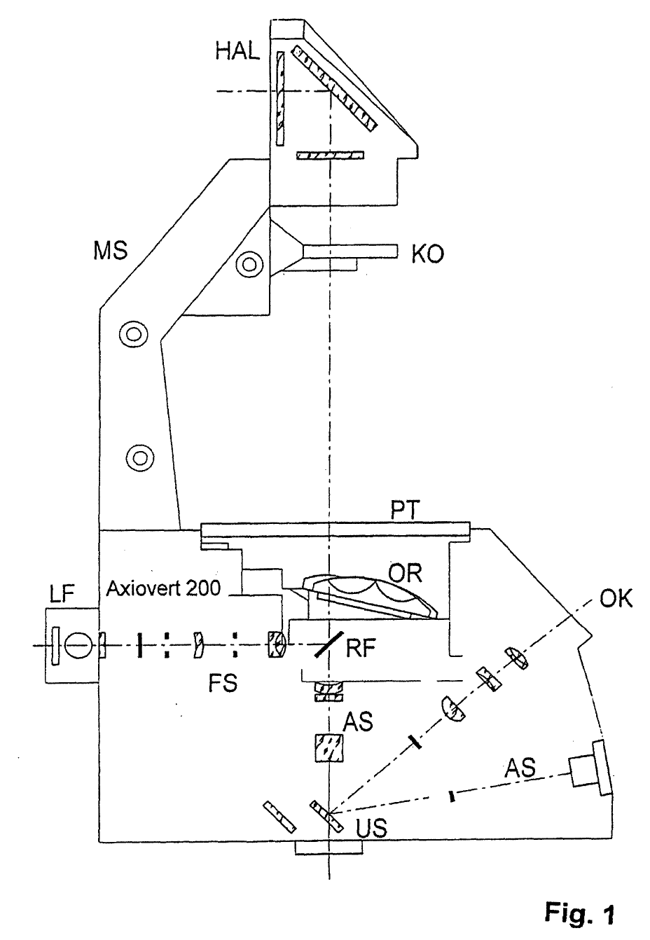

The beam path of an inverted microscope is shown schematically in FIG. 1.

A halogen lamp HAL at the microscope stand MS illuminates an object located on the specimen stage PT via a condenser KO. Located below the specimen stage is an objective turret OR, shown without the objective lenses which are inserted therein, and a reflector RF which is part of a, reflector turret, not shown, and which can be switched on to reflect in a fluorescence excitation beam path FS of a light source LF. The imaging beam path AS is deflected in the direction of the eyepiece OK (not shown) of the observer by a deflecting mirror US. Further, a recording beam path AS is provided for photographic recordings.

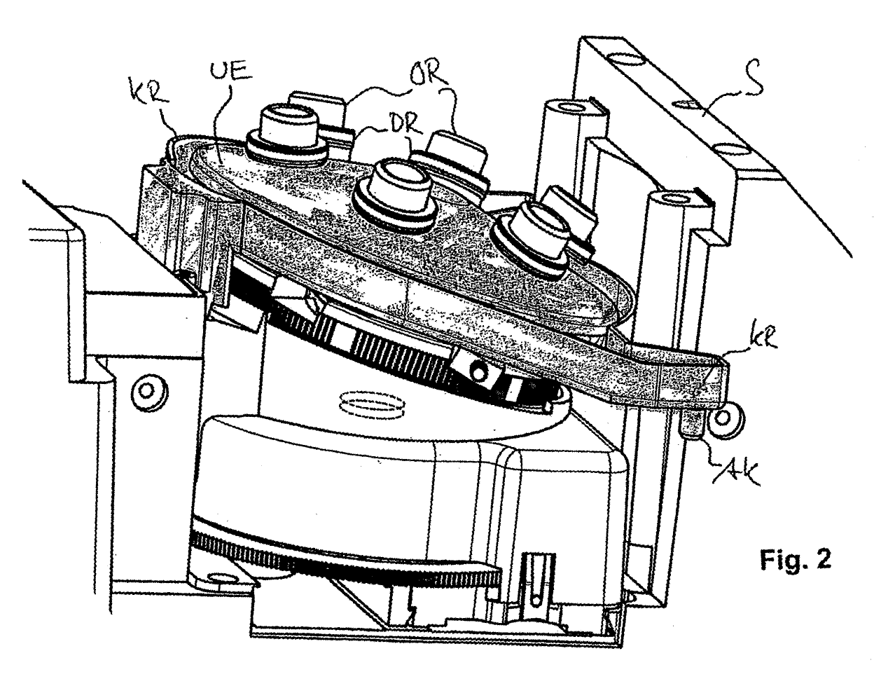

FIG. 2 shows the stand S and the objective turret OR of an inverted microscope in an oblique view. The specimen stage is not shown in this drawing. It has a kidney-shaped recess, for example, to ensure that the objective lenses can be swiveled in without obstruction. When examining liquid specimens which are handled, it is unavoidable that specimen liquid will spill over the edge of the specimen vessel and reach the bottom part of the microscope through the opening in the specimen stage.

A flexible coat UE made of plastic or rubber or a silicone mat is now advantageously provided for the objective turret, its shape being adapted to the shell-like shape of the objective turret. In this way, liquid that reaches the turret can continue to flow off and will not back up.

It has circular recesses or a plurality of radii adapted to commercially available objective lenses allowing the latter to come out. In addition, flexible sealing rings DR comprising, e.g., a silicone mat or a type of rubber such as Buna N can be provided in frictional engagement or positive engagement around the objective projections which prevents a flow through the edges of the coat UE.

Further, a collar KR is provided at the objective turret and fastened to the turret support. This collar KR terminates exactly at the edge with the coat and contains a circumferential gutter in which liquid flowing off collects and is accordingly stopped from flowing onto the stand. The gutter has at least one connecting piece with a flow-off duct AK which can be connected to a collecting vessel via a tube in order to capture the liquid flowing off.

1. Protective device for preventing moisture from entering the parts of an inverted microscope located below the specimen stage, wherein a preferably flexible cover is provided for the objective turret, which cover is adapted to the shape of the turret and has recesses for the objectives and an at least partially circumferential gutter below the cover for collecting liquid.

2. Protective device according to claim 1, wherein the cover and the gutter are separate structural components so that the cover can be exchanged.

3. Protective device according to claim 1 or 2, wherein the gutter has at least one flow-off piece for the liquid.

4. Protective device according to claim 1, 2 or 3, wherein separate, removable sealing rings are provided at the objectives in addition to the cover.
